(19) United States
(12) Patent Application Publication
(10) Pub. No.: US 2002/0083450 A1
(43) Pub. Date: Jun. 27, 2002

(54) Method and system for content-based broadcasted program selection

(76) Inventors: Yakov Kamen, Cupertino, CA (US); Dan Kikinis, Saratoga, CA (US)

Correspondence Address: John P. Ward, BLAKELY, SOKOLOFF, TAYLOR & ZAFMANN LLP, Seventh Floor, 12400 Wilshire Boulevard, Los Angeles, CA, 90025-1026, US

(21) Appl. No.: 10/008,229

(22) Filed: Nov. 30, 2001

Related U.S. Application Data
(60) Provisional application No. 60/250,977, filed on Dec. 1, 2000.

(51) Int. Cl. H04N 5/445; G06F 3/00

(52) U.S. Cl. 725/45

(57) ABSTRACT

A first set of categories of content of broadcasted programs is provided. A category from the first set of categories of content of broadcasted programs is added to a second set of categories of content of broadcasted programs upon the category from the first set of categories of content of broadcasted programs being selected. Alternatively, a category from the first set of categories of content of broadcasted programs is added to the second set of categories of content of broadcasted programs upon a broadcasted program viewing device being tuned, for a period of time at least equal to a first predetermined threshold, to at least one broadcasted program predetermined to contain content included in the category from the first set of categories of content of broadcasted programs.

### RELATED APPLICATIONS

The present application claims priority to the provisional filed application entitled Dynamic generation of a content-based favorite channels list, filed on Dec. 1, 2001, Serial No. 60/250,977, which is also incorporated herein by reference.

### FIELD OF THE INVENTION

The invention relates to the field of television. More specifically, the invention relates to the determination of television viewing preferences based on the content of the broadcasted programs viewed.

### BACKGROUND OF THE INVENTION

The abundance of broadcasted programs available for viewing at any given time on a broadcasted program viewing device, such as a television, can be overwhelming. Given the limited duration of most broadcasted programs, finding one broadcasted program directed towards a desired subject matter, or content, among the many other broadcasted programs being simultaneously broadcast on different channels is often a frustrating endeavor. By the time one has cycled through all of the many channels available, the broadcast program containing the desired content may be almost, if not completely, finished.

Although some channels may be oriented towards one category of content, it can be difficult at times to determine with any specificity, based only on the title of a channel or a sampling of the programs broadcasted on a channel, any correspondence between content and channel. All too often, only a general classification of the content offered on various channels can be made. Furthermore, channels typically broadcasting programs including desired content may on occasion broadcast programs lacking desired content, and channels typically broadcasting programs lacking desired content may occasionally broadcast programs including desired content.

With so many channels and times available, and with broadcasted programs sometimes being changed to a different time slot or even to a different channel, keeping track of the times and channels corresponding to even known broadcasted programs can be impractical. Although charts may list some major channels and even a perfunctory description of broadcasted programs shown at various times on those channels, such charts are frequently underinclusive in instances when only major channels are listed and are often unmanageable when all available channels are listed. Likewise, schemes which incorporate the display of a multiplicity of small snapshots of programs being currently broadcasted on a number of channels suffer from the same deficiencies. So many broadcasted programs, so little time.

Although some devices may attempt to record broadcasted programs which are suspected to be of interest to a viewer for later viewing, the suspicion is misplaced much of the time. Present devices in some cases make the assumption in choosing which broadcasted programs to record that people who tune in to program “X” will also want to view other programs, however disparate in content those other programs are from program “X”, viewed by other people who also tuned in to program “X”. This assumption may be inaccurate. Such devices fail in their selection of broadcasted programs to make use of a category to which the content of a broadcasted program belongs.

### SUMMARY OF THE INVENTION

A first set of categories of content of broadcasted programs is provided. A category from the first set of categories of content of broadcasted programs is added to a second set of categories of content of broadcasted programs upon the category from the first set of categories of content of broadcasted programs being selected. Alternatively, a category from the first set of categories of content of broadcasted programs is added to the second set of categories of content of broadcasted programs upon a broadcasted program viewing device being tuned, for a period of time at least equal to a first predetermined threshold, to at least one broadcasted program predetermined to contain content included in the category from the first set of categories of content of broadcasted programs.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIGS. 1A and 1B illustrate flow diagrams for adding a category to a set of categories of content of broadcasted programs, according to one embodiment;

FIGS. 2A and 2B illustrate flow diagrams for removing a category from a set of categories of content of broadcasted programs, according to one embodiment;

FIGS. 3A and 3B illustrate flow diagrams for tuning a broadcasted program viewing device to a broadcasted program containing content from a category in a set of categories, according to one embodiment;

FIG. 4 illustrates a flow diagram for verifying the adding of a category to a set of categories of content of broadcasted programs, according to one embodiment; and

FIG. 5 illustrates a system for adding a category to a set of categories of content of broadcasted programs, according to one embodiment.

### DETAILED DESCRIPTION

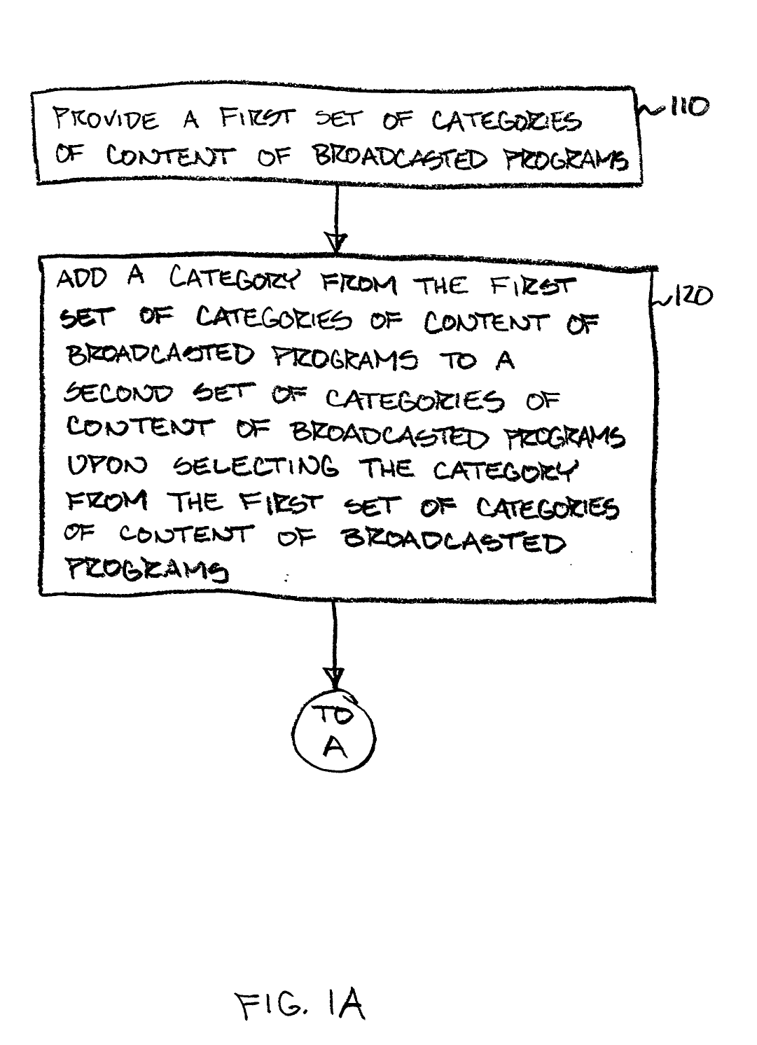

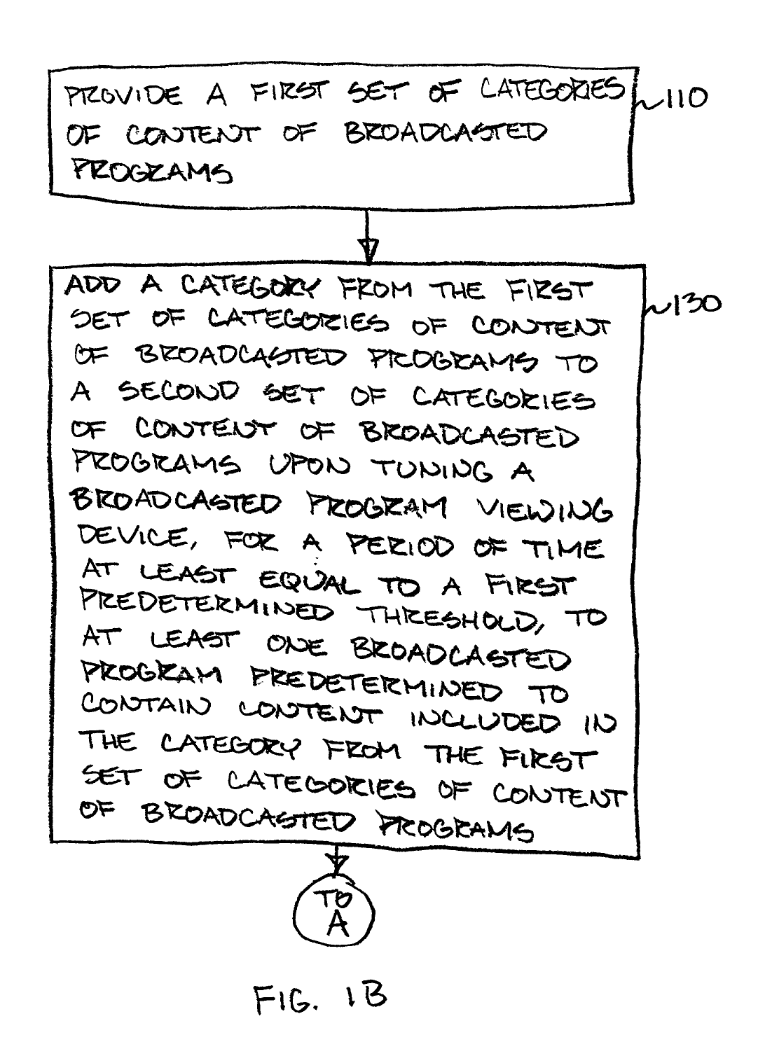

FIG. 1A illustrates a flow diagram for adding a category to a set of categories of content of broadcasted programs, according to one embodiment. In process block 110, a first set of categories of content of broadcasted programs is provided. In one embodiment, the first set of categories of content of broadcasted programs is provided by a media provider. A media provider may be a cable television provider, a satellite television provider, or any other provider of broadcasted programs through a communications medium. The communications medium may be a cable, such as a fiber optic or copper cable, or the communications medium may be a form of unguided medium, such as electromagnetic waves traveling through the air. Whatever the communications medium used, in process block 120, a category from the first set of categories of content of broadcasted programs is added to a second set of categories of content of broadcasted programs upon a selecting of the category from the first set of categories of content of broadcasted programs. Selecting a category of content may be accomplished by using a television remote control to navigate a menu displayed on a television screen.

FIG. 1B illustrates a flow diagram for adding a category to a set of categories of content of broadcasted programs, according to one embodiment. Again, in process block 110, a first set of categories of content of broadcasted programs are provided. But in this embodiment, a category from the first set categories of content of broadcasted programs is added to a second set of categories of content of broadcasted programs upon a tuning of a broadcasted program viewing device, such as a television, for a period of time at least equal to a first predetermined threshold, to at least one broadcasted program predetermined to contain content included in the category from the first set categories of content of broadcasted programs. For example, if a television was tuned to any number of broadcasted programs containing content predetermined to be in the “sports” content category over a combined span of 45 minutes, and if the first predetermined threshold was equal to 30 minutes, then the “sports” category from the first set of categories of content of broadcasted programs would be added to the second set of categories of content of broadcasted programs. In one embodiment, a category may be added based on the number of times that broadcasted programs including content fitting into the category are selected, rather than the length of time that such broadcasted programs are viewed.

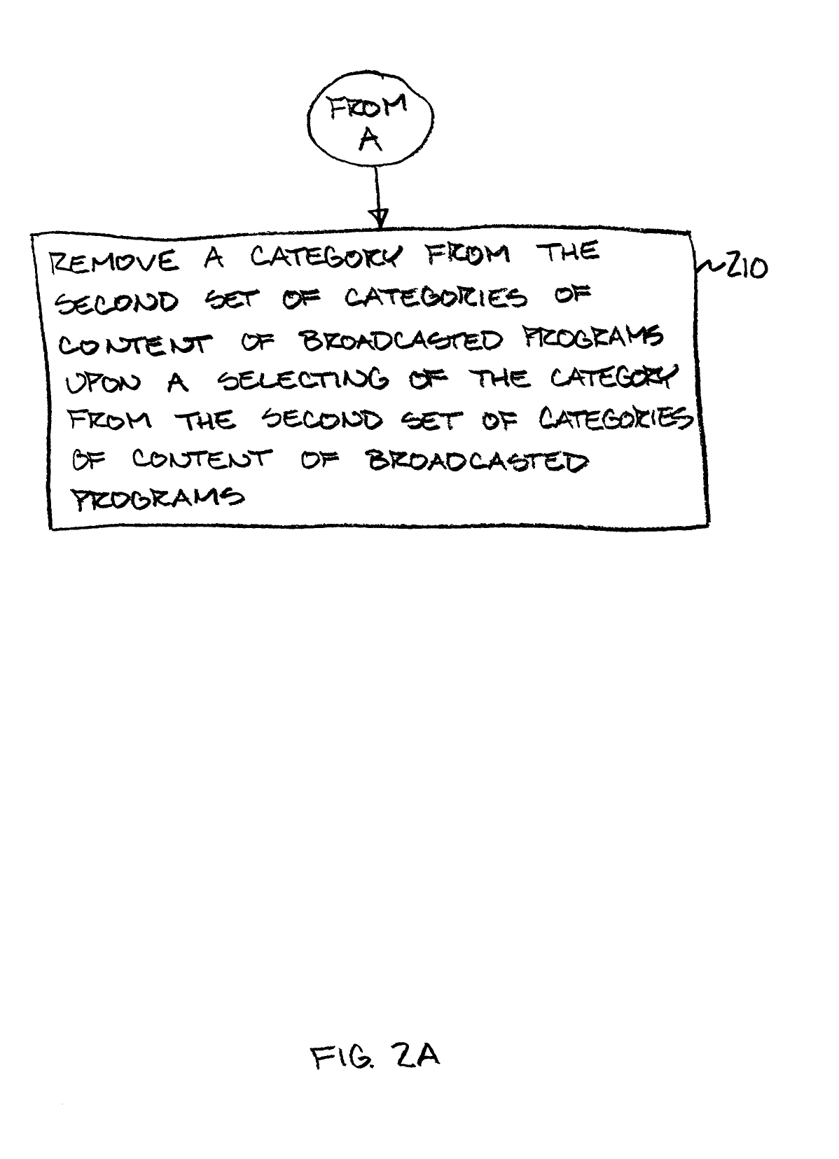

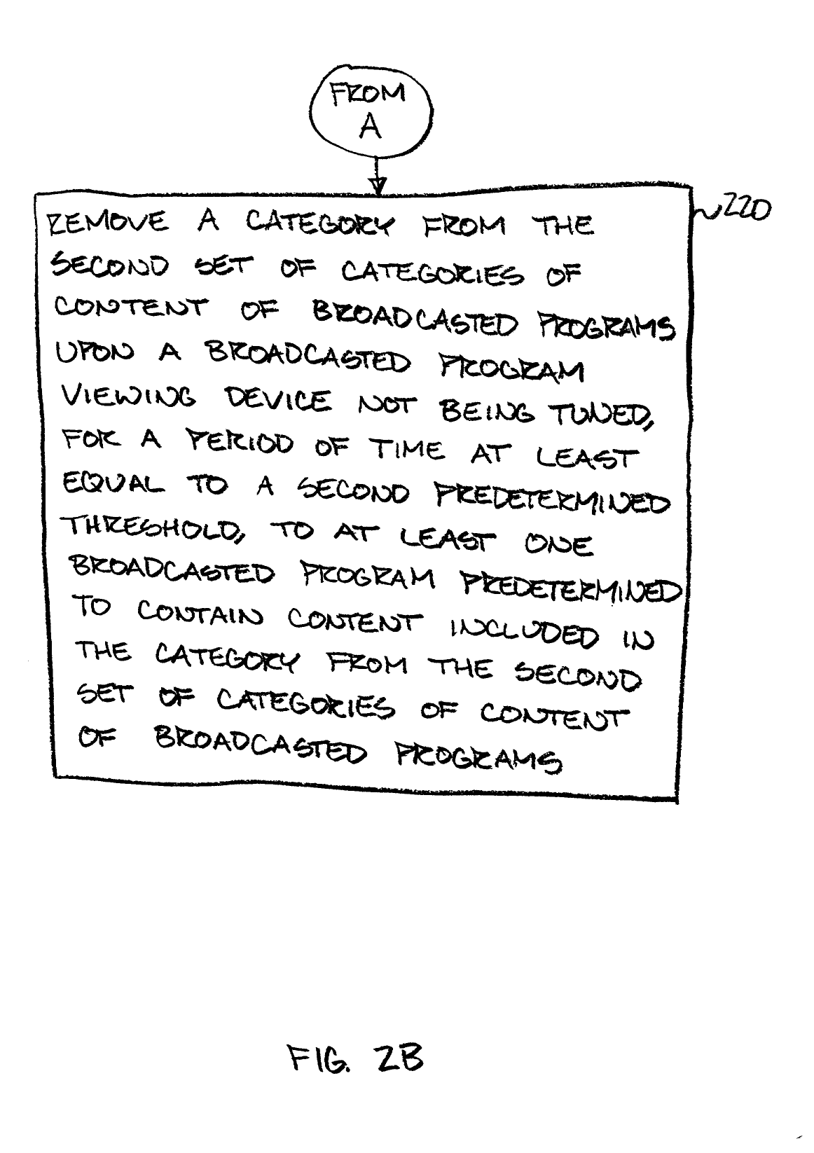

FIG. 2A illustrates a flow diagram for removing a category from a set of categories of content of broadcasted programs, according to one embodiment. In process block 210, a category from the second set of categories of content of broadcasted programs is removed upon a selecting of the category from the second set of categories of content of broadcasted programs. The selection may be accomplished with a remote control and a menu displayed on a television screen as described above.

FIG. 2B illustrates a flow diagram for removing a category from a set of categories of content of broadcasted programs, according to one embodiment. In this embodiment, shown in process block 220, a category is removed from the second set of categories of content of broadcasted programs upon a broadcasted program viewing device not being tuned, for a period of time at least equal to a second predetermined threshold, to at least one broadcasted program predetermined to contain content included in the category from the second set of categories of content of broadcasted programs. For example, if the second set of categories of content of broadcasted programs includes the category of content “news”, and the television is not tuned, over a week or some other predetermined period of time, to broadcasted programs fitting into the “news” content category for at least 30 minutes, and if the second predetermined threshold is 30 minutes, then the category “news” would be removed from the second set of categories of content of broadcasted programs.

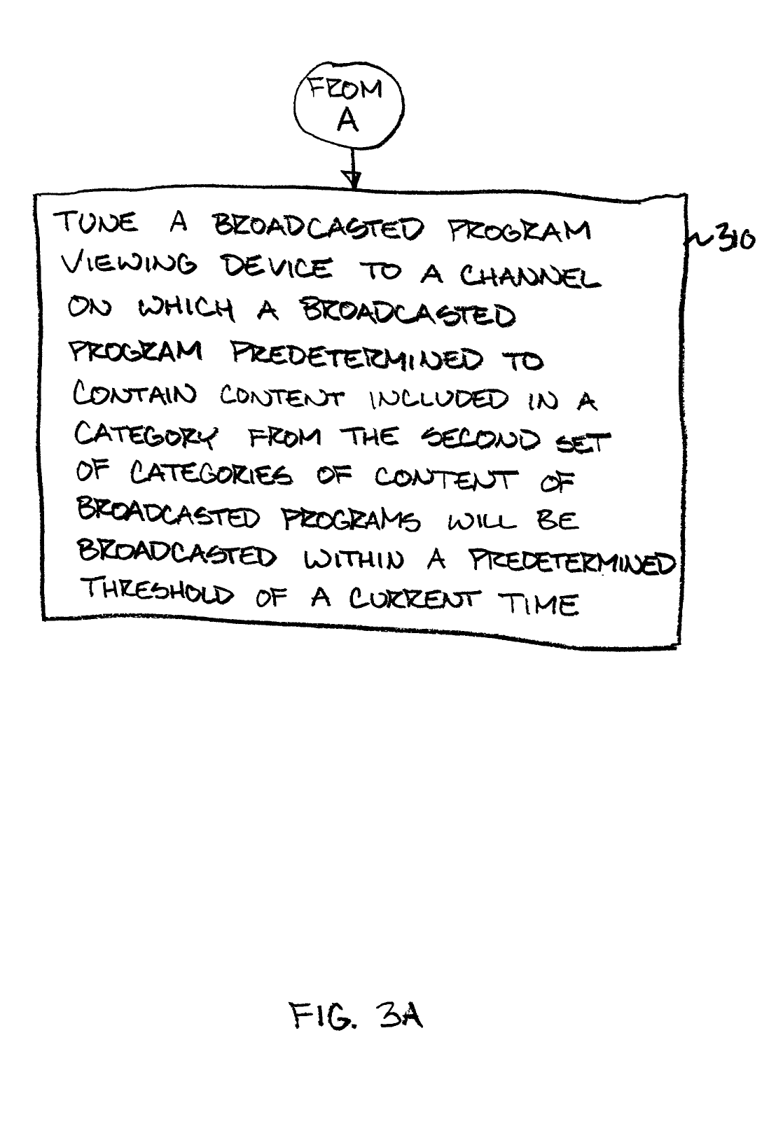

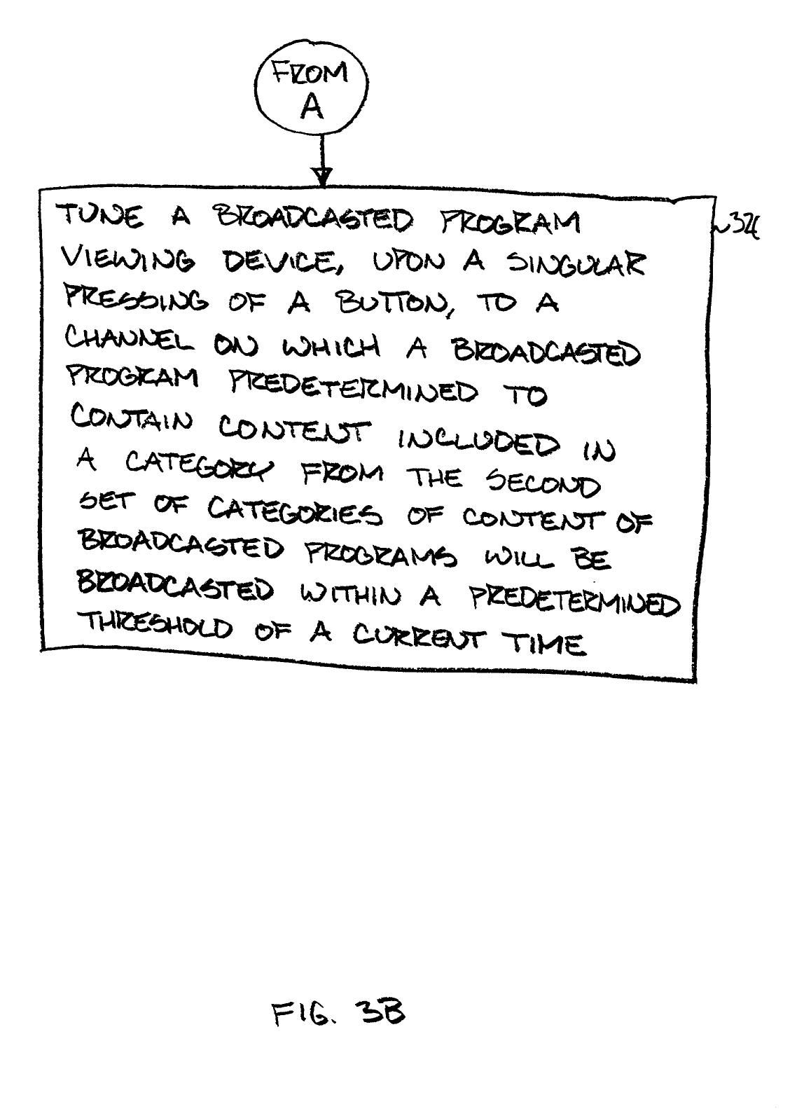

FIG. 3A illustrates a flow diagram for tuning a broadcasted program viewing device to a broadcasted program containing content from a category in a set of categories, according to one embodiment. In process block 310, a broadcasted program viewing device, such as a television, is tuned to a channel on which a broadcasted program predetermined to contain content included in a category from the second set of categories of content of broadcasted programs will be broadcasted within a predetermined threshold of a current time. If the predetermined threshold is zero then the broadcasted program viewing device would be tuned to a channel on which a broadcasted program predetermined to contain content included in a category from the second set of categories of content of broadcasted programs is currently being broadcasted. If the predetermined threshold was 30 minutes, then the broadcasted program viewing device would be tuned to a channel on which a broadcasted program predetermined to contain content included in the category from the second set of categories of content of broadcasted programs would be broadcasted within the next half hour. For example, if the second set of categories of content of broadcasted programs included categories “sport”, “news”, and “comedy”, and the predetermined threshold was 30 minutes, then the broadcasted program viewing device would be tuned to a channel on which a broadcasted program predetermined to contain content from the “sports”, “news”, or “comedy” categories was either currently being broadcasted or would be broadcasted within the next 30 minutes. In one embodiment, if the broadcasted program viewing device is tuned to a channel which is not currently but will in the future be broadcasting such a broadcasted program, then a guide is displayed somewhere on the screen to indicate the upcoming broadcast of the program.

FIG. 3B illustrates a flow diagram for tuning a broadcasted program viewing device to a broadcasted program containing content included in a category from a set of categories, according to one embodiment. In process block 320, a broadcasted program viewing device, upon a singular pressing of a button, is tuned to a channel on which a broadcasted program predetermined to contain content included in a category from the second set of categories of content of broadcasted programs will be broadcasted within a predetermined threshold of a current time. In one embodiment, the button is a “favorites” button on a television remote control. Of course, other embodiments are possible which do not use a button. Any device which may be used to tune a broadcasted program viewing device will suffice.

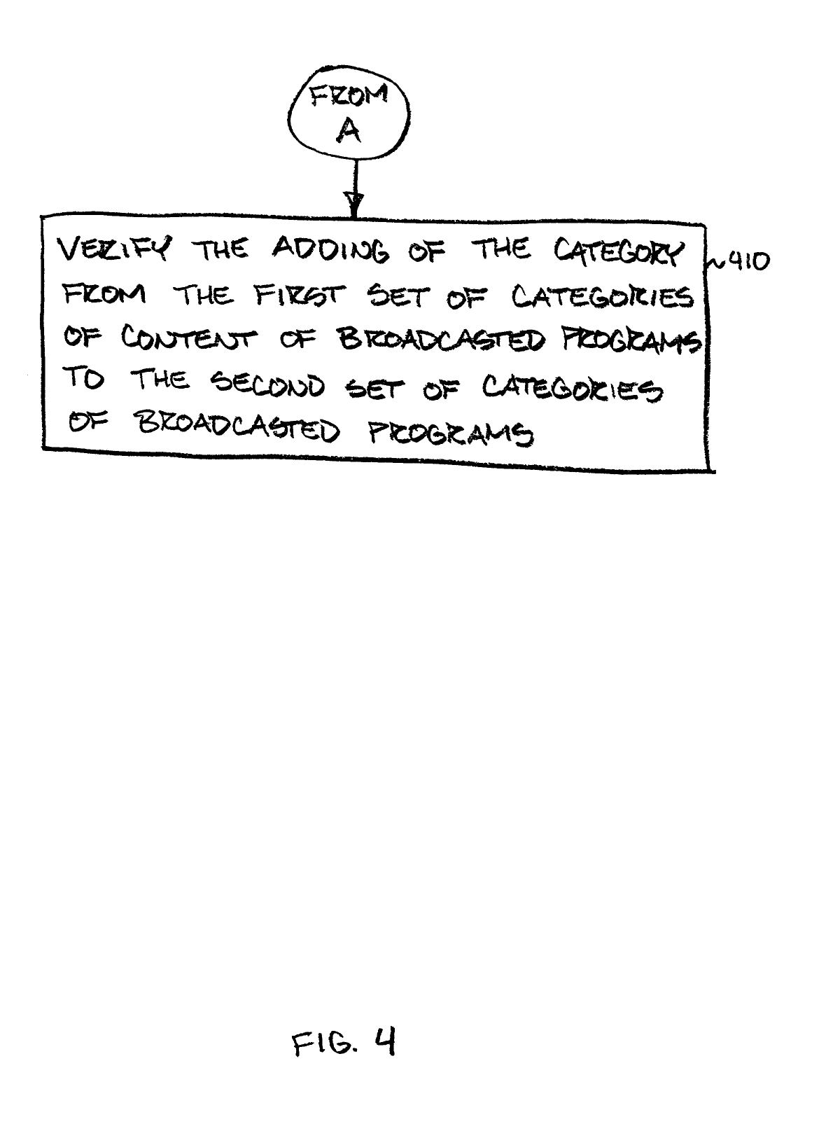

FIG. 4 illustrates a flow diagram for verifying the adding of a category to a set of categories of content of broadcasted programs, according to one embodiment. In process block 410, the adding of the category from the first set of categories of content of broadcasted programs to the second set of categories of broadcasted programs is verified. In one embodiment, a viewer is prompted before a category is added to the second set of categories of broadcasted programs. In one embodiment, a viewer may either allow or disallow the addition of the category to the second set of categories of content of broadcasted programs. This prevents undesirable programs from inadvertently and mistakenly being added to the second set of categories of content of broadcasted programs.

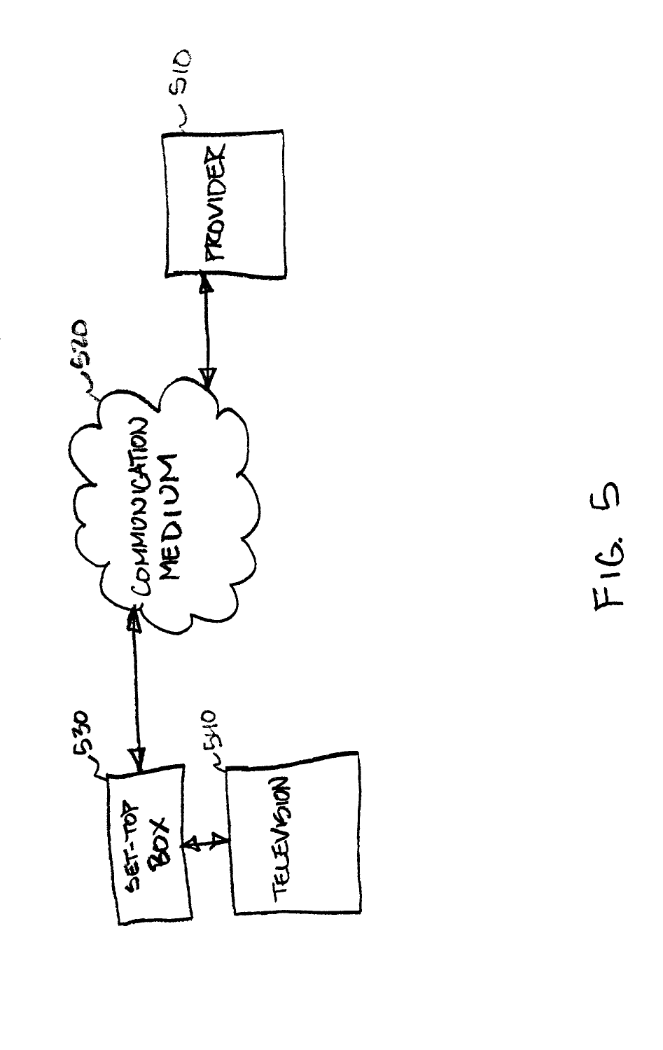

FIG. 5 illustrates a system for adding a category to a set of categories of content of broadcasted programs, according to one embodiment. In one embodiment, the system includes a first unit to provide a first set of categories of content of broadcasted programs. A second unit is coupled with the first unit to add a category from the first set of categories of content of broadcasted programs to a second set of categories of content of broadcasted programs upon either a selection of a category from the first set of categories of content of broadcasted programs or a tuning of a broadcasted program viewing device, for a period of time at least equal to a first predetermined threshold, to at least one broadcasted program predetermined to contain content included in the category from the first set of categories of content of broadcasted programs. In one embodiment, both the first unit and the second unit are incorporated into a set-top box 530. In one embodiment, both the first unit and the second unit are incorporated into a television 540. In one embodiment, the first unit is incorporated into the set-top box 530, and the first unit is a provider 510. In one embodiment, provider 510 is a computer. In one embodiment, set-top box 530 communicates with provider 510 through a communication medium 520. Communication medium 520 may be a cable or some form of unguided medium. In one embodiment, set-top box 530 is not present, and provider 510 communicates directly with television 540 through communication medium 520.

In one embodiment, the second unit is also to remove a category from the second set of categories of content of broadcasted programs upon a selecting of the category from the second set on categories of categories of content of broadcasted programs. In one embodiment, the second unit is also to remove a category from the second set of categories of content of broadcasted programs upon a broadcasted program viewing device not being tuned, for a period of time at least equal to a second predetermined threshold, to at least one broadcasted program predetermined to contain content included in the category from the second set of categories of content of broadcasted programs.

In one embodiment, the second unit is also to tune a broadcasted program viewing device to a channel on which a broadcasted program predetermined to contain content included in the category from the second set of categories of content of broadcasted programs would be broadcasted within a predetermined threshold of a current time. In one embodiment, this tuning is accomplished upon a singular pressing of a button. As mentioned above, devices other than a button may also be used to accomplish the tuning. In one embodiment, the second unit is also to verify an adding of category from the first set of categories of content of broadcasted programs to the second set of categories of content of broadcasted programs.

In one embodiment, the second set of categories of content of broadcasted programs includes a fixed, immutable subset of categories.

The classification of a broadcasted program into a category of content may be based on an analysis of data available from an electronic programming guide. This analysis could be based upon the title of the broadcasted program, or on a description of the broadcasted program. In one embodiment, the first set of categories of content of broadcasted programs is determined by a media provider. In one embodiment, a different first set of categories of content of broadcasted programs may be generated especially for different types of viewers. For example, one set of categories could be generated for sports fans. Another set of categories could be generated for people who like to watch news.

The embodiments described above can be implemented using software in a TV viewing system. Such a TV viewing system can be implemented in many ways. A typical approach to implementation uses a set-top box that contains, among other things, a CPU, storage (e.g., RAM, ROM, etc.), a receiving network adapter, and circuitry to drive a viewing system such as a TV, monitor, projector, etc. All of these elements are not necessarily shown, but are well know in the art. For purposes of the embodiments described below, any other grouping, such as a TV with a built-in CPU, or a personal computer with TV capabilities are considered to be equivalent. Such television viewing system are typically supplied with TV content by system operators, including but not limited to cable provider/operators, satellite provider/operators, broadcasters, overbuilders, etc.

The method and apparatus disclosed herein may be integrated into advanced Internet- or network-based knowledge systems as related to information retrieval, information extraction, and question and answer systems. The system has a processor coupled to a bus. Also coupled to the bus are a memory which may contain instructions. Additional components coupled to the bus are a storage device (such as a hard drive, floppy drive, CD-ROM, DVD-ROM, etc.), an input device (such as a keyboard, mouse, light pen, bar code reader, scanner, microphone, joystick, etc.), and an output device (such as a printer, monitor, speakers, etc.). Of course, an exemplary computer system could have more components than these or a subset of the components listed.

The method described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version.

Alternatively, the logic to perform the methods as discussed above, could be implemented in additional computer and/or machine readable media, such as discrete hardware components as large-scale integrated circuits (LSI's), application-specific integrated circuits (ASIC's), firmware such as electrically erasable programmable readonly memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. One skilled in the art will appreciate that the embodiments described above apply also to satellite and internet and telephone systems as well as the cable systems described. Accordingly, the specification and drawings are to be regarded in an illustrative rather than a restrictive sense.

What is claimed is:

1. A method comprising:
providing a first set of categories of broadcasted programs; and
adding a category from the first set to a second set of categories of broadcasted programs in response to one of selecting the category from the first set and tuning a broadcasted program viewing device, for a period of time at least equal to a first predetermined threshold, to at least one broadcasted program predetermined to be in the category from the first set.

2. The method of claim 1, further comprising:
removing a category from the second set upon a selecting of the category from the second set.

3. The method of claim 1, further comprising:
removing a category from the second set upon a broadcasted program viewing device not being tuned, for a period of time at least equal to a second predetermined threshold, to at least one broadcasted program predetermined to be in the category from the second set.

4. The method of claim 1, further comprising:
tuning a broadcasted program viewing device to a channel on which a broadcasted program predetermined to be in a category from the second set will be broadcasted within a predetermined threshold of a current time.

5. The method of claim 1, further comprising:
tuning a broadcasted program viewing device, upon a singular pressing of a button, to a channel on which a broadcasted program predetermined to be in a category from the second set will be broadcasted within a predetermined threshold of a current time.

6. The method of claim 1, further comprising:
verifying the adding of the category from the first set to the second set.

7. A machine-readable medium that provides instructions that, when executed by a machine, cause the machine to perform operations comprising:
providing a first set of categories of broadcasted programs; and
adding a category from the first set to a second set of categories of broadcasted programs in response to one of selecting the category from the first set and tuning a broadcasted program viewing device, for a period of time at least equal to a first predetermined threshold, to at least one broadcasted program predetermined to be in the category from the first set.

8. The machine-readable medium of claim 7, wherein operations further comprise:
removing a category from the second set upon a selecting of the category from the second set.

9. The machine-readable medium of claim 7, wherein operations further comprise:
removing a category from the second set upon a broadcasted program viewing device not being tuned, for a period of time at least equal to a second predetermined threshold, to at least one broadcasted program predetermined to be in the category from the second set.

10. The machine-readable medium of claim 7, wherein operations further comprise:
tuning a broadcasted program viewing device to a channel on which a broadcasted program predetermined to be in a category from the second set will be broadcasted within a predetermined threshold of a current time.

11. The machine-readable medium of claim 7, wherein operations further comprise:
tuning a broadcasted program viewing device, upon a singular pressing of a button, to a channel on which a broadcasted program predetermined to be in a category from the second set will be broadcasted within a predetermined threshold of a current time.

12. The machine-readable medium of claim 7, wherein operations further comprise:
verifying the adding of the category from the first set to the second set.

13. A system comprising:
a first unit to provide a first set of categories of content of broadcasted programs; and
a second unit coupled with the first unit to add a category from the first set to a second set of categories of broadcasted programs in response to one of selecting the category from the first set and tuning a broadcasted program viewing device, for a period of time at least equal to a first predetermined threshold, to at least one broadcasted program predetermined to be in the category from the first set.

14. The system of claim 13, wherein the second unit is also to remove a category from the second set upon a selecting of the category from the second set.

15. The system of claim 13, wherein the second unit is also to remove a category from the second set upon a broadcasted program viewing device not being tuned, for a period of time at least equal to a second predetermined threshold, to at least one broadcasted program predetermined to be in the category from the second set.

16. The system of claim 13, wherein the second unit is also to tune a broadcasted program viewing device to a channel on which a broadcasted program predetermined to be in a category from the second set will be broadcasted within a predetermined threshold of a current time.

17. The system of claim 13, wherein the second unit is also to tune a broadcasted program viewing device, upon a singular pressing of a button, to a channel on which a broadcasted program predetermined to be in a category from the second set will be broadcasted within a predetermined threshold of a current time.

18. The system of claim 13, wherein the second unit is also to verify an adding of the category from the first set to the second set.
